(19) United States
(12) Patent Application Publication
(10) Pub. No.: US 2025/0367577 A1
(43) Pub. Date: Dec. 4, 2025

(54) COMPOSITIONS AND METHODS FOR REDUCING FOAM

(71) Applicant: Ecolab USA Inc., St. Paul, MN (US)

(72) Inventors: Xiaojin Harry LI, Bartlett, IL (US); Omer GUL, Rosenberg, TX (US); Kameswara VYAKARANAM, Sugar Land, TX (US)

(73) Assignee: Ecolab USA Inc., St. Paul, MN (US)

(21) Appl. No.: 19/219,353

(22) Filed: May 27, 2025

Related U.S. Application Data
(60) Provisional application No. 63/652,991, filed on May 29, 2024.

(51) Int. Cl. B01D 19/04

(52) U.S. Cl. CPC B01D 19/0495; B01D 19/0431

(57) ABSTRACT

The present disclosure provides methods and compositions for reducing an amount of foam in a medium. A method may include adding a composition to the medium and reducing the amount of foam in the medium. The composition may include an anti-foam composition that includes an imide-containing compound. The anti-foam composition may comprise, for example, a detacking composition, a fuel cloud point depressant, and/or a crude oil pour point depressant.

### TECHNICAL FIELD

The present disclosure provides compositions and methods for reducing foam in a medium.

### BACKGROUND

Surfactants are agents used in a variety of industries to alter the surface or interface properties or emulsify immiscible materials. For example, surfactants are commonly used as dispersants that detackify polymer pellet products. Such detackification prevents aggregation and maintains free flow for storage, formulation, and processing. However, using the surfactants may result in excess foam, which can disrupt polymer processing. Surfactant use in many other industries similarly results in undesired foam production and accumulation. Under certain circumstances, foam-causing surfactants may be released or produced in various industrial processes.

To control the foam, Si-based products are effective but often there are downstream issues or problems, such as depositions, catalyst poising or unwanted ash residues, in various industrial processes.

### BRIEF SUMMARY

In certain aspects, the present disclosure provides compositions and methods for reducing foam in a medium. A method of the present disclosure may include adding an anti-foam composition to the medium, wherein the anti-foam composition comprises an imide-containing compound. The method also comprises reducing the amount of foam in the medium.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

“Oxo” refers to an oxygen atom double-bonded to a carbon atom.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(-N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C (O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions and methods for reducing an amount of foam in a medium. In some embodiments, an anti-foam composition is added to the medium and the foam generation in the medium is thereby prevented or reduced. Additionally or alternatively, the anti-foam composition of the present disclosure may be added to any medium that comprises foam and the amount of foam will be reduced by the anti-foam composition. An anti-foam composition of the present disclosure may comprise an imide-containing compound.

Preventing foam from forming in a medium includes fully preventing foam formation or preventing foam from forming to a certain extent. For example, if an anti-foam composition of the present disclosure is added to a medium, the amount of foam that would have formed in the medium (if the anti-foam composition was not added) may be reduced by about 10%, about 20%, about 30%, about 40%, about 50%, about 60%, about 70%, about 80%, about 90%, about 95%, or about 100%.

The anti-foam compositions disclosed herein are useful, for example, in reducing amounts of foam in polymer pellet compositions and processes, delayed coker compositions and processes, fuel compositions and processes, and oil compositions and processes. The anti-foam compositions can additionally be used as detacking compositions, fuel cloud point depressants, and crude oil pour point depressants.

In some embodiments, the imide-containing compound of the anti-foam composition is a reaction product of an amine and a cyclic compound having an alkyl α-olefin. In certain embodiments, the alkyl α-olefin is a C₅ to C₆₀ α-olefin. For example, the alkyl α-olefin may be a C₅-C₅₅ alkyl α-olefin, a C₅-C₅₀ alkyl α-olefin, a C₅-C₄₅ alkyl α-olefin, a C₅-C₄₀ alkyl α-olefin, a C₅-C₃₅ alkyl α-olefin, a C₅-C₃₀ alkyl α-olefin, a C₅-C₂₅ alkyl α-olefin, a C₅-C₂₀ alkyl α-olefin, a C₅-C₁₅ alkyl α-olefin, a C₅-C₁₀ alkyl α-olefin, a C₁₀-C₆₀ alkyl α-olefin, a C₁₅-C₆₀ alkyl α-olefin, a C₂₀-C₆₀ alkyl α-olefin, a C₂₅-C₆₀ alkyl α-olefin, a C₃₀-C₆₀ alkyl α-olefin, a C₃₅-C₆₀ alkyl α-olefin, a C₄₀-C₆₀ alkyl α-olefin, a C₄₅-C₆₀ alkyl α-olefin, a C₅₀-C₆₀ alkyl α-olefin, or a C₅₅-C₆₀ alkyl α-olefin.

In some embodiments, the cyclic compound is selected from maleic anhydride, maleimide, N-substituted maleimide, or any combination thereof.

The imide-containing compound may comprise the following formula:

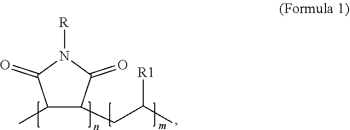

wherein R is H or a substituted or un-substituted, saturated or unsaturated C₁ to C₂₂ alkyl, alkenyl, alkynyl, or aryl group, a nitrogen-containing group, a phosphorus-containing group, or a sulfur-containing group; wherein n is an integer from about 1 to about 10,000; and wherein Ri is a substituted or un-substituted, saturated or unsaturated C₃ to C₅₈ alkyl, alkenyl, alkynyl, or aryl group. In some embodiments, the substituted, saturated or unsaturated C₁ to C₂₂ alkyl, alkenyl, alkynyl, or aryl group includes an oxygen atom and/or an oxygen-containing group.

In some embodiments, n is an integer selected from about 1 to about 10,000, about 1 to about 8,000, about 1 to about 6,000, about 1 to about 4,000, about 1 to about 2,000, about 1 to about 1,000, about 1 to about 800, about 1 to about 600, about 1 to about 400, about 1 to about 200, about 1 to about 100, about 1 to about 80, about 1 to about 60, about 1 to about 40, about 1 to about 20, about 1 to about 10, about 1 to about 5, about 20 to about 10,000, about 40 to about 10,000, about 60 to about 10,000, about 80 to about 10,000, about 100 to about 10,000, about 200 to about 10,000, about 400 to about 10,000, about 600 to about 10,000, about 800 to about 10,000, about 1,000 to about 10,000, about 2,000 to about 10,000, about 4,000 to about 10,000, about 6,000 to about 10,000, or about 8,000 to about 10,000.

In some embodiments, m is an integer selected from about 1 to about 10,000, about 1 to about 8,000, about 1 to about 6,000, about 1 to about 4,000, about 1 to about 2,000, about 1 to about 1,000, about 1 to about 800, about 1 to about 600, about 1 to about 400, about 1 to about 200, about 1 to about 100, about 1 to about 80, about 1 to about 60, about 1 to about 40, about 1 to about 20, about 1 to about 10, about 1 to about 5, about 20 to about 10,000, about 40 to about 10,000, about 60 to about 10,000, about 80 to about 10,000, about 100 to about 10,000, about 200 to about 10,000, about 400 to about 10,000, about 600 to about 10,000, about 800 to about 10,000, about 1,000 to about 10,000, about 2,000 to about 10,000, about 4,000 to about 10,000, about 6,000 to about 10,000, or about 8,000 to about 10,000.

In some embodiments, R is H. However, R may also be a substituted or un-substituted, saturated or unsaturated C₁ to C₂₂ alkyl, alkenyl, alkynyl, or aryl group, such as a C₁-C₂₁, a C₁-C₂₀, a C₁-C₁₉, a C₁-C₁₈, a C₁-C₁₇, a C₁-C₁₆, a C₁-C₁₅, a C₁-C₁₄, a C₁-C₁₃, a C₁-C₁₂, a C₁-C₁₁, a C₁-C₁₀ , a C₁-C₉, a C₁-C₈, a C₁-C₇, a C₁-C₆, a C₁-C₅, a C₁-C₄, a C₁-C₃, a C₁-C₂, a C₂-C₂₂, a C₃-C₂₂, a C₄-C₂₂, a C₅-C₂₂, a C₆-C₂₂, a C₇-C₂₂, a C₈-C₂₂, a C₉-C₂₂, a C₁₀-C₂₂, a C₁₁-C₂₂, a C₁₂-C₂₂, a C₁₃-C₂₂, a C₁₄-C₂₂, a C₁₅-C₂₂, a C₁₆-C₂₂, a C₁₇-C₂₂, a C₁₈-C₂₂, a C₁₉-C₂₂, a C₂₀-C₂₂, or a C₂₁-C₂₂ substituted or un-substituted, saturated or unsaturated alkyl, alkenyl, alkynyl, or aryl group.

In some embodiments, the a substituted, saturated or unsaturated C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, or C₂₂ alkyl, alkenyl, alkynyl, or aryl group is substituted with an oxygen-containing group, a nitrogen-containing group, a phosphorus-containing group, and/or a sulfur-containing group.

The oxygen-containing group may be, for example, an alcohol, a phenol, an ether, an ester, an aldehyde, a ketone, a carboxylic acid, or any combination thereof.

The nitrogen-containing group may be, for example, an amine or an amide.

The phosphorus-containing group may be, for example, a phosphate group.

The sulfur-containing group may be, for example, a sulfate.

As mentioned above, R₁ may be a substituted or un-substituted, saturated or unsaturated C₃ to C₅₈ alkyl, alkenyl, alkynyl, or aryl group. For Example, R₁ may be selected from a substituted or un-substituted, saturated or unsaturated C₃ to C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group.

In certain embodiments, the imide-containing compound comprises the following formula:

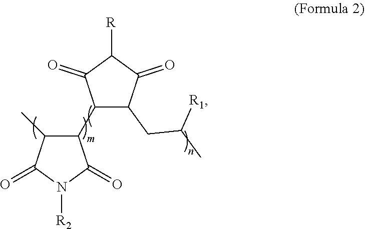

wherein R is H, a substituted or un-substituted, saturated or unsaturated C₁ to C₂₂ alkyl, alkenyl, alkynyl, or aryl group; wherein m is an integer from about 1 to about 3,000; wherein n is an integer from about 1 to about 10,000; wherein R₁ is a substituted or un-substituted, saturated or unsaturated C₃ to C₅₈ alkyl, alkenyl, alkynyl, or aryl group; and wherein R₂ is H or a substituted or un-substituted, saturated or unsaturated C₁ to C₂₂ alkyl, alkenyl, alkynyl, or aryl group. In some embodiments, the substituted, saturated or unsaturated C₁ to C₂₂ alkyl, alkenyl, alkynyl, or aryl group includes an oxygen-containing group, a nitrogen-containing group, a phosphorus-containing group, a sulfur-containing group, or any combination thereof.

In some embodiments, m is an integer selected from about 1 to about 3,000; about 1 to about 2,500; about 1 to about 2,000; about 1 to about 1,500; about 1 to about 1,000; about 1 to about 800; about 1 to about 600; about 1 to about 400; about 1 to about 200; about 1 to about 100; about 1 to about 80; about 1 to about 60; about 1 to about 40; about 1 to about 20; about 1 to about 10; about 1 to about 5; about 20 to about 3,000; about 40 to about 3,000; about 60 to about 3,000; about 80 to about 3,000; about 100 to about 3,000; about 200 to about 3,000; about 400 to about 3,000; about 600 to about 3,000; about 800 to about 3,000; about 1,000 to about 3,000; about 1,500 to about 3,000; about 2,000 to about 3,000; or about 2,500 to about 3,000.

In some embodiments, n is an integer selected from about 1 to about 10,000; about 1 to about 8,000; about 1 to about 6,000; about 1 to about 4,000; about 1 to about 2,000; about 1 to about 1,000; about 1 to about 800; about 1 to about 600; about 1 to about 400; about 1 to about 200; about 1 to about 100; about 1 to about 80; about 1 to about 60; about 1 to about 40; about 1 to about 20; about 1 to about 10; about 1 to about 5; about 20 to about 10,000; about 40 to about 10,000; about 60 to about 10,000; about 80 to about 10,000; about 100 to about 10,000; about 200 to about 10,000; about 400 to about 10,000; about 600 to about 10,000; about 800 to about 10,000; about 1,000 to about 10,000; about 2,000 to about 10,000; about 4,000 to about 10,000; about 6,000 to about 10,000; or about 8,000 to about 10,000.

In some embodiments, R is H. However, R may be a substituted or un-substituted, saturated or unsaturated C₁ to C₂₂, C₁-C₂₀, C₁-C₁₈, C₁-C₁₆, C₁-C₁₄, C₁-C₁₂, C₁-C₁₀, C₁-C₈, C₁-C₆, C₁-C₄, C₁-C₂, C₂-C₂₂, C₄-C₂₂, C₆-C₂₂, C₈-C₂₂, C₁₀-C₂₂, C₁₂-C₂₂, C₁₄-C₂₂, C₁₆-C₂₂, C₁₈-C₂₂, or C₂₀-C₂₂ alkyl, alkenyl, alkynyl, or aryl group.

In some embodiments, the substituted, saturated or unsaturated C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, or C₂₂ alkyl, alkenyl, alkynyl, or aryl group is substituted with an oxygen-containing group, a nitrogen-containing group, a phosphorus-containing group, a sulfur-containing group, or any combination thereof.

The oxygen-containing group may be, for example, an alcohol, a phenol, an ether, an ester, an aldehyde, a ketone, or a carboxylic acid.

The nitrogen-containing group may be, for example, an amine or an amide.

The phosphorus-containing group may be, for example, a phosphate group.

The sulfur-containing group may be, for example, a sulfate.

In some embodiments, R₁ is a substituted or un-substituted, saturated or unsaturated C₃ to C₅₈ alkyl, alkenyl, alkynyl, or aryl group. For example, R₁ may be selected from a substituted or un-substituted, saturated or unsaturated C₃ to C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, Or C₅₅-C₅₈ alkyl, alkenyl, alkynyl, or aryl group.

In some embodiments, R₂ is H. However, R₂ may be a substituted or un-substituted, saturated or unsaturated C₁ to C₂₂ alkyl, alkenyl, alkynyl, or aryl group. For example, R₂ may be a substituted or un-substituted, saturated or unsaturated C₁-C₂₀, C₁-C₁₈, C₁-C₁₆, C₁-C₁₄, C₁-C₁₂, C₁-C₁₀, C₁-C₈, C₁-C₆, C₁-C₄, C₁-C₂, C₂-C₂₂, C₄-C₂₂, C₆-C₂₂, C₈-C₂₂, C₁₀-C₂₂, C₁₂-C₂₂, C₁₄-C₂₂, C₁₆-C₂₂, C₁₈-C₂₂, or C₂₀-C₂₂ alkyl, alkenyl, alkynyl, or aryl group.

In some embodiments, the substituted, saturated or unsaturated C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, or C₂₂ alkyl, alkenyl, alkynyl, or aryl group is substituted with an oxygen-containing group, a nitrogen-containing group, a phosphorus-containing group, a sulfur-containing group, or any combination thereof.

The oxygen-containing group may be, for example, an alcohol, a phenol, an ether, an ester, an aldehyde, a ketone, or a carboxylic acid.

The nitrogen-containing group may be, for example, an amine or an amide.

The phosphorus-containing group may be, for example, a phosphate group.

The sulfur-containing group may be, for example, a sulfate.

In certain aspects, the imide-containing compound has the following formula:

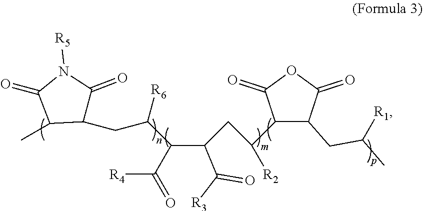

wherein R₁ is a substituted or un-substituted, saturated or unsaturated C₃ to C₅₈ alkyl, alkenyl, alkynyl, or aryl group; wherein R₂ is a substituted or un-substituted, saturated or unsaturated C₃ to C₅₈ alkyl, alkenyl, alkynyl, or aryl group; wherein R₃ is selected from an OH group, an amine group, a substituted or un-substituted, saturated or unsaturated C₃ to C₅₈ alkyl, alkenyl, alkynyl, or aryl group, an O-alkyl group, or an N-alkyl group; wherein R₄ is selected from an OH group, a substituted or un-substituted, saturated or unsaturated C₃ to C₅₈ alkyl, alkenyl, alkynyl, or aryl group, an O-alkyl group, or an N-alkyl group; wherein R₅ is H or a substituted or un-substituted, saturated or unsaturated C₁ to C₂₂ alkyl, alkenyl, alkynyl, or aryl group, and the substituted, saturated or unsaturated C₁ to C₂₂ alkyl, alkenyl, alkynyl, or aryl group may be substituted with an oxygen-containing group, a nitrogen-containing group, a phosphorus-containing group, a sulfur-containing group, or any combination thereof; wherein R₆ is a substituted or un-substituted, saturated or unsaturated C₃ to C₅₈ alkyl, alkenyl, alkynyl, or aryl group; wherein n is an integer from about 1 to about 5,000; wherein m is an integer from about 1 to about 5,000; and wherein p is an integer from about 1 to about 5,000.

In some embodiments, n is an integer selected from about 1 to about 5,000; about 1 to about 4,000; about 1 to about 3,000; about 1 to about 2,000; about 1 to about 1,000; about 1 to about 800; about 1 to about 600; about 1 to about 400; about 1 to about 200; about 1 to about 100; about 1 to about 80; about 1 to about 60; about 1 to about 40; about 1 to about 20; about 1 to about 10; about 1 to about 5; about 20 to about 3,000; about 40 to about 3,000; about 60 to about 3,000; about 80 to about 3,000; about 100 to about 3,000; about 200 to about 3,000; about 400 to about 3,000; about 600 to about 3,000; about 800 to about 3,000; about 1,000 to about 3,000; or about 2,000 to about 3,000.

In some embodiments, m is an integer selected from about 1 to about 5,000; about 1 to about 4,000; about 1 to about 3,000; about 1 to about 2,000; about 1 to about 1,000; about 1 to about 800, about 1 to about 600; about 1 to about 400; about 1 to about 200; about 1 to about 100; about 1 to about 80; about 1 to about 60; about 1 to about 40; about 1 to about 20; about 1 to about 10; about 1 to about 5; about 20 to about 3,000; about 40 to about 3,000; about 60 to about 3,000; about 80 to about 3,000; about 100 to about 3,000; about 200 to about 3,000; about 400 to about 3,000; about 600 to about 3,000; about 800 to about 3,000; about 1,000 to about 3,000; or about 2,000 to about 3,000.

In some embodiments, p is an integer selected from about 1 to about 5,000; about 1 to about 4,000; about 1 to about 3,000; about 1 to about 2,000; about 1 to about 1,000; about 1 to about 800; about 1 to about 600; about 1 to about 400; about 1 to about 200; about 1 to about 100; about 1 to about 80; about 1 to about 60; about 1 to about 40; about 1 to about 20; about 1 to about 10; about 1 to about 5; about 20 to about 3,000; about 40 to about 3,000; about 60 to about 3,000; about 80 to about 3,000; about 100 to about 3,000; about 200 to about 3,000; about 400 to about 3,000; about 600 to about 3,000; about 800 to about 3,000; about 1,000 to about 3,000; or about 2,000 to about 3,000.

In some embodiments, R₁ is a substituted or un-substituted, saturated or unsaturated C₃ to C₅₈ alkyl, alkenyl, alkynyl, or aryl group. For example, R₁ may be selected from a substituted or un-substituted, saturated or unsaturated C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₂-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group.

In some embodiments, R₂ is a substituted or un-substituted, saturated or unsaturated C₃ to C₅₈ alkyl, alkenyl, alkynyl, or aryl group. For example, R₂ may be selected from a substituted or un-substituted, saturated or unsaturated C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₂-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group.

In some embodiments, Rs is an OH group. However, Rs may also be a substituted or un-substituted, saturated or unsaturated C₃ to C₅₈ alkyl, alkenyl, alkynyl, or aryl group. For example, Rs may be selected from a substituted or un-substituted, saturated or unsaturated C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₂-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group alkyl group.

In some embodiments, R₃ is an O-alkyl group or an N-alkyl group.

In some embodiments, R₄ is an OH group. However, R₄ may also be a substituted or un-substituted, saturated or unsaturated C₃ to C₅₈ alkyl, alkenyl, alkynyl, or aryl group. For example, R₄ may selected from a substituted or un-substituted, saturated or unsaturated C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₂-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group.

In some embodiments, R₄ is an O-alkyl group or an N-alkyl group.

In some embodiments, R₅ is H. However, R₅ may also be a substituted or un-substituted, saturated or unsaturated C₁ to C₂₂ alkyl, alkenyl, alkynyl, or aryl group. For example, R₅ may be a substituted or un-substituted, saturated or unsaturated C₁-C₂₀, C₁-C₁₈, C₁-C₁₆, C₁-C₁₄, C₁-C₁₂, C₁-C₁₀, C₁-C₈, C₁-C₆, C₁-C₄, C₁-C₂, C₂-C₂₂, C₄-C₂₂, C₆-C₂₂, C₈-C₂₂, C₁₀-C₂₂, C₁₂-C₂₂, C₁₄-C₂₂, C₁₆-C₂₂, C₁₈-C₂₂, or C₂₀-C₂₂ alkyl, alkenyl, alkynyl, or aryl group.

In some embodiments, the substituted, saturated or unsaturated C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, or C₂₂ alkyl group is substituted with an oxygen-containing group, a nitrogen-containing group, a phosphorus-containing group, and/or a sulfur-containing group.

The oxygen-containing group may be, for example, an alcohol, a phenol, an ether, an ester, an aldehyde, a ketone, or a carboxylic acid.

The nitrogen-containing group may be, for example, an amine or an amide.

The phosphorus-containing group may be, for example, a phosphate group.

The sulfur-containing group may be, for example, a sulfate.

In some embodiments, R₆ is a substituted or un-substituted, saturated or unsaturated C₃ to C₅₈ alkyl, alkenyl, alkynyl, or aryl group. For example, R₆ may be selected from a substituted or un-substituted, saturated or unsaturated C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group.

The imide-containing compound may also comprise the following formula:

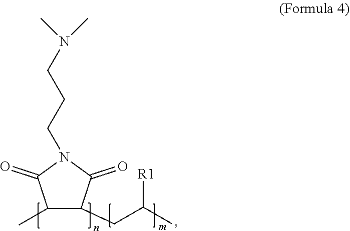

wherein R₁ is a substituted or un-substituted, saturated or unsaturated C₃ to C₅₈ alkyl, alkenyl, alkynyl, or aryl group; and wherein n is an integer from about 1 to about 10,000.

In some embodiments, n is an integer selected from about 1 to about 10,000, about 1 to about 8,000, about 1 to about 6,000, about 1 to about 4,000, about 1 to about 2,000, about 1 to about 1,000, about 1 to about 800, about 1 to about 600, about 1 to about 400, about 1 to about 200, about 1 to about 100, about 1 to about 80, about 1 to about 60, about 1 to about 40, about 1 to about 20, about 1 to about 10, about 1 to about 5, about 20 to about 10,000, about 40 to about 10,000, about 60 to about 10,000, about 80 to about 10,000, about 100 to about 10,000, about 200 to about 10,000, about 400 to about 10,000, about 600 to about 10,000, about 800 to about 10,000, about 1,000 to about 10,000, about 2,000 to about 10,000, about 4,000 to about 10,000, about 6,000 to about 10,000, or about 8,000 to about 10,000.

In some embodiments, m is an integer selected from about 1 to about 10,000, about 1 to about 8,000, about 1 to about 6,000, about 1 to about 4,000, about 1 to about 2,000, about 1 to about 1,000, about 1 to about 800, about 1 to about 600, about 1 to about 400, about 1 to about 200, about 1 to about 100, about 1 to about 80, about 1 to about 60, about 1 to about 40, about 1 to about 20, about 1 to about 10, about 1 to about 5, about 20 to about 10,000, about 40 to about 10,000, about 60 to about 10,000, about 80 to about 10,000, about 100 to about 10,000, about 200 to about 10,000, about 400 to about 10,000, about 600 to about 10,000, about 800 to about 10,000, about 1,000 to about 10,000, about 2,000 to about 10,000, about 4,000 to about 10,000, about 6,000 to about 10,000, or about 8,000 to about 10,000.

In some embodiments, R₁ is a substituted or un-substituted, saturated or unsaturated C₈ to C₆₀ alkyl, alkenyl, alkynyl, or aryl group. For example, R₁ may be selected from a C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group.

The imide-containing compound may also comprise the following formula:

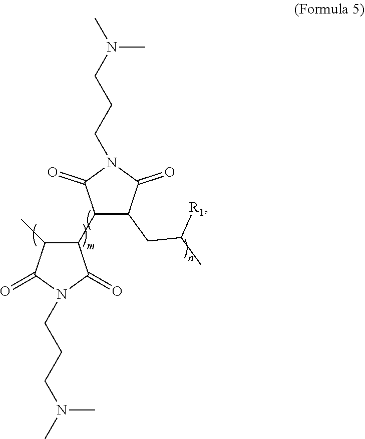

wherein R₁ is a substituted or un-substituted, saturated or unsaturated C₃ to C₅₈ alkyl, alkenyl, alkynyl, or aryl group; wherein m is an integer from about 1 to about 3,000; and wherein n is an integer from about 1 to about 10,000.

In some embodiments, n is an integer selected from about 1 to about 10,000, about 1 to about 8,000, about 1 to about 6,000, about 1 to about 4,000, about 1 to about 2,000, about 1 to about 1,000, about 1 to about 800, about 1 to about 600, about 1 to about 400, about 1 to about 200, about 1 to about 100, about 1 to about 80, about 1 to about 60, about 1 to about 40, about 1 to about 20, about 1 to about 10, about 1 to about 5, about 20 to about 10,000, about 40 to about 10,000, about 60 to about 10,000, about 80 to about 10,000, about 100 to about 10,000, about 200 to about 10,000, about 400 to about 10,000, about 600 to about 10,000, about 800 to about 10,000, about 1,000 to about 10,000, about 2,000 to about 10,000, about 4,000 to about 10,000, about 6,000 to about 10,000, or about 8,000 to about 10,000.

In some embodiments, R₁ is a substituted or un-substituted, saturated or unsaturated C₃ to C₅₈ alkyl, alkenyl, alkynyl, or aryl group. For example, R₁ may be selected from a substituted or un-substituted, saturated or unsaturated C₃-C₅₅, C₃-C₅₀, C₃-C₄₅, C₃-C₄₀, C₃-C₃₅, C₃-C₃₀, C₃-C₂₅, C₃-C₂₀, C₃-C₁₅, C₃-C₁₀, C₁₀-C₅₈, C₁₅-C₅₈, C₂₀-C₅₈, C₂₅-C₅₈, C₃₀-C₅₈, C₃₅-C₅₈, C₄₀-C₅₈, C₄₅-C₅₈, C₅₀-C₅₈, or C₅₅-C₅₈ alkyl, alkenyl, alkynyl, or aryl group alkyl group.

In some embodiments, the composition comprising the imide-containing compound excludes a silicon atom, e.g., a silicon-containing compound, a silicon-containing polymer, a silicon-containing composition, and/or a silicon-containing product.

In certain embodiments, the imide-containing compound is a reaction product of a poly (alpha-olefin-c-maleic anhydride) and 3-(dimethylamino)-1-propylamine (e.g.,

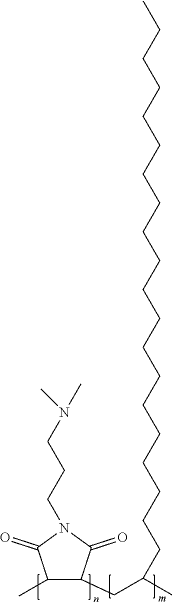

where m is an integer selected from about 1 to about 250, such as about 1 to about 200, about 1 to about 150, about 1 to about 100, about 1 to about 50, about 5 to about 50, or about 5 to about 100, and n is an integer selected from about 1 to about 250, such as about 1 to about 200, about 1 to about 150, about 1 to about 100, about 1 to about 50, about 5 to about 50, or about 5 to about 100.

A composition of the present disclosure may comprise from about 1 wt. % to about 100 wt. % of the imide-containing compound. For example, a composition may include from about 1 wt. % to about 95 wt. %, about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 1 wt. % to about 5 wt. %, about 5 wt. % to about 100 wt. %, about 10 wt. % to about 100 wt. %, about 20 wt. % to about 100 wt. %, about 30 wt. % to about 100 wt. %, about 40 wt. % to about 100 wt. %, about 50 wt. % to about 100 wt. %, about 60 wt. % to about 100 wt. %, about 70 wt. % to about 100 wt. %, about 80 wt. % to about 100 wt. %, or about 90 wt. % to about 100 wt. % of the imide-containing compound.

The molecular weight of the imide-containing compound is not particularly limited. As an example, the imide-containing compound may have a number average molecular weight of about 500 Daltons (Da) to about 5,000,000 Da. For example, the imide-containing compound may have a number average molecular weight of about 500 Da to about 4,500,000 Da, about 500 Da to about 4,000,000 Da, about 500 Da to about 3,000,000 Da, about 500 Da to about 2,000,000 Da, about 500 to about 1,000,000 Da, about 500 Da to about 800,000 Da, about 500 Da to about 600,000 Da, about 500 Da to about 400,000 Da, about 500 Da to about 200,000 Da, about 500 to about 100,000 Da, about 500 to about 50,000 Da, about 500 to about 25,000 Da, about 500 Da to about 10,000 Da, about 500 Da to about 5,000 Da, about 500 Da to about 1,000 Da, about 1,000 Da to about 5,000,000 Da, about 5,000 Da to about 5,000,000 Da, about 10,000 Da to about 5,000,000 Da, about 25,000 Da to about 5,000,000 Da, about 50,000 Da to about 5,000,000 Da, about 100,000 Da to about 5,000,000 Da, about 500,000 Da to about 5,000,000 Da, about 1,000,000 Da to about 5,000,000 Da, about 2,000,000 Da to about 5,000,000 Da, about 3,000,000 Da to about 5,000,000 Da, or about 4,000,000 Da to about 5,000,000 Da.

In some embodiments, a composition as disclosed herein may include a solvent. In some embodiments, a composition may include from about 0.1 wt. % to about 99 wt. %, from about 0.1 wt. % to about 90 wt. %, from about 0.1 wt. % to about 80 wt. %, from about 0.1 wt. % to about 70 wt. %, from about 0.1 wt. % to about 60 wt. %, from about 0.1 wt. % to about 50 wt. %, from about 0.1 wt. % to about 40 wt. %, from about 0.1 wt. % to about 30 wt. %, from about 0.1 wt. % to about 20 wt. %, from about 0.1 wt. % to about 10 wt. %, from about 0.1 wt. % to about 5 wt. %, from about 1 wt. % to about 99 wt. %, from about 10 wt. % to about 99 wt. %, from about 20 wt. % to about 99 wt. %, from about 30 wt. % to about 99 wt. %, from about 40 wt. % to about 99 wt. %, from about 50 wt. % to about 99 wt. %, from about 60 wt. % to about 99 wt. %, from about 70 wt. % to about 99 wt. %, from about 80 wt. % to about 99 wt. %, or from about 90 wt. % to about 99 wt. % of a solvent.

Illustrative, non-limiting examples of solvents include water, heavy aromatic naphtha, a refined petroleum solvent, xylene, toluene, kerosene, a hydrotreated light distillate hydrocarbon, a middle distillate hydrocarbon, diglyme, a plant-based oil, an alcohol, a polyol, an organic acid, any combination thereof.

A composition of the present disclosure may also comprise one or more residual α-olefins or additives, such as an oil, a fatty acid, a fatty alcohol, a non-ionic surfactant, an ionic surfactant, a hydrotrope, or any combination thereof.

In some embodiments, compositions of the present disclosure may be prepared by combining the imide-containing compound with a solvent, optionally forming a solution. If desired, one or more additional additives may be added to the composition.

As an illustrative example, a compound of the present disclosure may be prepared in accordance with the following:

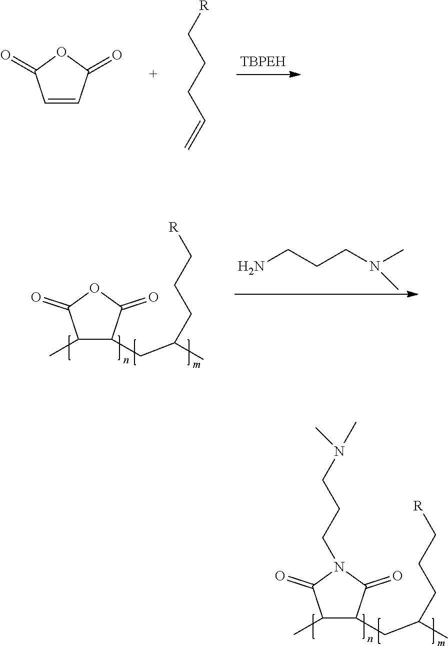

wherein R may be from about 1 to about 30, such as about 1 to about 25, about 1 to about 20, about 1 to about 15, about 1 to about 10, or about 1 to about 5; TBPEH is t-butyl peroxy-2-ethylhexanoate; and the reaction solvent may include, for example, heavy aromatic naphtha.

The m is an integer selected from about 1 to about 250, such as about 1 to about 200, about 1 to about 150, about 1 to about 100, about 1 to about 50, about 5 to about 50, or about 5 to about 100, and n is an integer selected from about 1 to about 250, such as about 1 to about 200, about 1 to about 150, about 1 to about 100, about 1 to about 50, about 5 to about 50, or about 5 to about 100.

The foregoing synthesis represents only an illustrative embodiment of the present disclosure and different steps and/or products are encompassed by the present disclosure. For example, the final product/imide-containing compound includes all structural variations, such as alternating copolymer Formulae 1 and 4 and random polymer Formulae 2 and 5. Formula 3 products can be produced, for example, from the reaction of intermediates, such as partial imidation, partial esterification (e.g., at least one of the R₃ and R₄ is R—O), partial amidation (e.g., at least one of R₃ and R₄ is an amide, or partial hydrolysis (e.g., R₃/R₄═OH). In the reaction scheme, the chain length change can include alpha-olefin variation from C₅ to C₆₀ in total. For example, the chain length change can include alpha-olefin variation from C₅ to C₆₀, C₅ to C₅₀, C₅ to C₄₀, C₅ to C₃₀, C₅ to C₂₀, C₅ to C₁₀, C₁₀ to C₆₀, C₂₀ to C₆₀, C₃₀ to C₆₀, C₄₀ to C₆₀, or C₅₀ to C₆₀.

The compositions of the present disclosure may be used for reducing an amount of foam present in a medium and/or preventing/inhibiting foam from forming in a medium. The compositions may be used in any industry and/or added to any medium where it is desirable to reduce the amount of foam in a medium or prevent foam from forming in a medium.

The present disclosure also provides methods of reducing an amount of foam in a medium or preventing foam from forming in a medium. The term “preventing” may refer to completely preventing foam from forming, although it may also encompass allowing a certain amount of foam to form, albeit less foam than would have formed if the anti-foam composition had not been added to the medium. For example, after addition of an anti-foam composition, total foam production may be reduced by about 10%, about 20%, about 30%, about 40%, about 50%, about 60%, about 70%, about 80%, about 90%, or about 95%, as compared to the amount of foam that would have formed if the anti-foam composition had not been added. The anti-foam composition thus may completely prevent foam from forming or it may reduce an overall amount of foam that would have formed if the composition was not added to the medium.

In some embodiments, a method of the present disclosure may be carried out by treating a medium with an effective amount of a composition and/or an imide-containing compound as described herein. The methods may be carried out in aqueous mediums, hydrocarbon mediums, oil-containing mediums, gaseous mediums, or any combination thereof. For example, the compositions and methods may be used for reducing foam in polymer pellet compositions and processes, delayed coker compositions and processes, fuel and fuel feedstock compositions and processes, and/or oil compositions and processes. The anti-foam foam compositions can be used as detacking compositions, fuel cloud point depressants, and/or crude oil pour point depressants.

Aqueous mediums of the present disclosure include, but are not limited to, cooling water, papermaking process water, wastewater, warewashing water, paper/recycled pulp water, mining flotation pulp water, fossil fuel water, biofuel water, or any combination thereof.

The compositions may be used to control foam in laundry applications, warewashing, hygiene, food and beverage processes, wastewater treatment, process water treatment, papermaking processes, mining processes, and/or in cooling water.

The anti-foam compositions may be used in connection with pour point depressants, cloud point depressants, cold flow improvers, and/or antistatic fuel additives.

The compositions may be applied to the medium to provide any selected concentration of components. For example, the composition may be added to the medium provide an effective treating dose of the desired component of the composition, such as imide-containing compound, from about 0.1 to about 50,000 ppm. For example, the component, e.g., imide-containing compound, may be added in an amount of about 0.1 ppm to about 45,000 ppm, about 0.1 ppm to about 40,000 ppm, about 0.1 ppm to about 35,000 ppm, about 0.1 ppm to about 30,000 ppm, about 0.1 ppm to about 20,000 ppm, about 0.1 ppm to about 10,000, about 0.1 ppm to about 5,000 ppm, about 0.1 ppm to about 1,000 ppm, about 0.1 ppm to about 750 ppm, about 0.1 ppm to about 500 ppm, about 0.1 ppm to about 250 ppm, about 0.1 ppm to about 100 ppm, about 0.1 ppm to about 50 ppm, about 1 ppm to about 100 ppm, about 5 ppm to about 200 ppm, about 5 ppm to about 400 ppm, or about 25 ppm to about 300 ppm.

In accordance with the methods disclosed herein, the composition may be applied continuously, intermittently, in batch treatments, or a combination thereof.

The foregoing may be better understood by reference to the following examples, which are intended for illustrative purposes and are not intended to limit the scope of the disclosure or its application in any way.

### EXAMPLES

The general procedure is followed as below to make the products. Briefly, an alkyl α-olefin is added to a reactor, followed by addition of maleic anhydride and a heavy aromatic hydrocarbon solvent. This mixture is then gradually heated to about 135° C. with notrogen purging and t-butyl peroxy-2-ethylhexanoate is added portion-wise while controlling the reaction temperature at a temperature of less than about 150° C. by cooling, and then finally heated at about 135° C. for about 0.5-1.5 hours to complete the polymerization (Table 1).

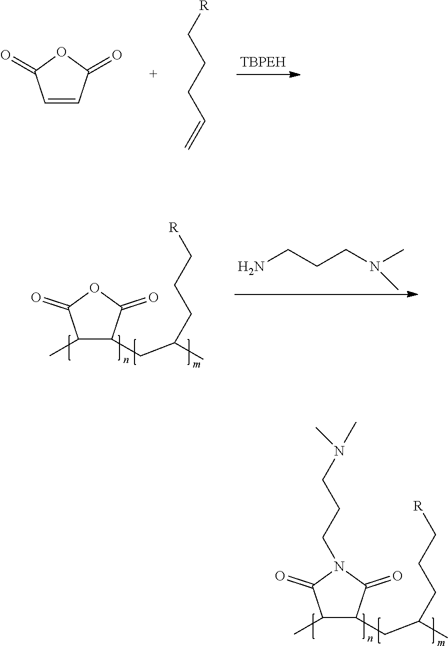

TABLE 1
Chemistry description of imide-containing compounds.

| | Polymer description (mol | | | | |
|---|---|---|---|---|---|
| | ratios of starting materials) | | | | Reaction residual |
| | α-olefin/ | α-olefin | | | α-olefin residual |
| Formula | MA | used | TBPEH | DMAPA | (by GC-MS) |
| AA | 0.704/1.000 | C₂₀-C₂₄ | 0.053 | 1.00 | 0.090 |
| BB | 0.808/1.000 | C₂₀-C₂₄ | 0.066 | 1.00 | 0.138 |
| CC | 0.808/1.000 | C₁₈ | 0.051 | 1.00 | 0.095 |
| DD | 0.808/1.000 | C₃₀+ | 0.086 | 1.00 | 0.150 by NMR |
| EE | 0.650/1.000 | C₃₀+ | 0.073 | 1.00 | 0.090 by NMR |
| FF | 0.600/1.000 | C₂₀-C₂₄ | 0.052 | 1.00 | NA |
| GG | 0.900/1.000 | C₂₀-C₂₄ | 0.069 | 1.00 | 0.166 |

MA: Maleic anhydride
TBPEH: t-butyl peroxy-2-ethylhexanoate - initiator
DMAPA: 3-(Dimethylamino)-1-propylamine
Polymerization solvent: heavy aromatic naphtha

The ability of various imide-containing compounds to reduce an amount of foam in a medium was determined by measuring foam height after dosing samples containing foam formed from a non-ionic surfactant containing solution. The foam control performance of the imide-containing compounds was compared to a silicon-based anti-foam compound.

The surfactant used for the tests was a fatty alcohol ethoxylate surfactant prepared in water. The 1,000 ppm stock solution of the surfactant was prepared by adding 1 g to 1 L of water=0.1%=1,000 ppm. The surfactant was soluble in the solution and vigorously foamed when shaken.

Anti-foam performance tests were conducted by comparing the foam height of a shaken glass jar of 100 mL of the surfactant stock alone to a solution in which 200 microliters (μL) of an anti-foam compound (either an imide-containing compound or a silicon-containing compound) was added to 100 ml of the surfactant solution (i.e., a 2:1 ratio). After shaking the glass jars, the time to reduce the foam was recorded.

Anti-foam tests were conducted according to ASTM Test 892. 100 mL of the surfactant stock was added to a 1,000 mL graduated cylinder, and nitrogen gas was flowed into the cylinder at a rate of 725 mL/min. The foam height was measured at 15 second intervals up to two minutes. A blank, control test initially performed (without any anti-foam added), and the foam heights were recorded in mL.

Foam reduction performance of various anti-foam compositions were compared to a silicon-containing anti-foam composition.

The foam reduction performance of imide-containing anti-foam compounds at about 2,000 ppm dosage was determined and are reported as foam height in mL as a function of time (seconds(s)). The results are shown in Table 2.

TABLE 2
Anti-foam performance of imide-containing anti-foam
compounds compared to a silicon-containing compound.

| | | Foam | | | |
|---|---|---|---|---|---|
| | | height | | | |
| | | (mL) | Foam | Foam | Foam |
| | Foam | silicon- | height | height | height |
| | height | containing | (mL) | (mL) | (mL) |
| | (mL) | anti-foam | FORMULA | FORMULA | FORMULA |
| Time | surfactant | (1,000 | AA (2,000 | BB (2,000 | CC (2,000 |
| (sec) | only | ppm) | ppm) | ppm) | ppm) |
| 15 | 250 | 25 | 40 | 80 | 100 |
| 30 | 400 | 25 | 40 | 80 | 140 |
| 45 | 590 | 25 | 40 | 100 | 100 |
| 60 | 750 | 25 | 40 | 100 | 80 |
| 75 | 900 | 25 | 40 | 100 | 70 |
| 90 | 1000 | 25 | 40 | 120 | 90 |

Formula AA contained about 1,000 ppm of surfactant alcohols, C₁₂₋₁₄-secondary, ethoxylated, and the imide-containing compound was AA (Table 1) (about 2,000 ppm) at a ratio of about 1:2. Formula BB contained the same surfactant in the same ratio but the imide-containing compound was BB (Table 1), and Formula CC contained the same surfactant in same ratio but the imide-containing compound was CC (Table 1).

The surfactant only data relates to a composition excluding an imide-containing compound and the silicon-containing anti-foam represents a composition including 1,000 ppm of the same surfactant used in Formulae AA, BB, and CC plus 1,000 ppm of a silicone surfactant.

Imide-containing compounds were screened for foam control efficiency and compared with non-Si foam control benchmarks. The results are shown in Tables 3, 4, and 5.

Ecolab® PanTastic™ soap was used as a foaming composition. The soap comprises of ionic foaming surfactants, including secondary alkanesulphonates, sodium poly (oxyethylene) dodecyl ether sulfate, and amines, coco alkyldimethyl, n-oxides. It was diluted with DI water to form a 50% (w/w) foaming agent. The imide-containing compounds were added to heavy aromatic naphtha to form a 25% (w/w) concentration. To screen the chemistries foam control efficiencies at 50° C., all the test tubes and DI-water used were preheated in a 50° C. oven before used.

For the defoam tests, a soap foam test was performed first as described below. 1, 2, or 3 drops of the 50% soap solution (about 0.018 grams, about 0.036 grams, and about 0.054 grams, respectively) was added to a 60 mL centrifuge tube with 25 mL DI water, which was pre-heated to 50 degrees Celsius. The tube was screw-caped toughly, then vigorously hand-shook horizontally for 30 seconds, and then put on a tube holder for 2 minutes at room temperature. After two minutes, a picture was taken and the soap foam volume created was recorded by mL. Right after the soap foam test, a chemistry defoam test started immediately by unscrewing the soap foam test tube, followed by addition of a drop of a 25% imide-containing compound (about 0.020 grams) or benchmark product. The defoam volume was obtained following the same steps as described above in the soap foam test procedure. The defoam efficiency was determined as follows: ((soap foam volume−defoam volume)/soap foam volume)×100%.

For the antifoam tests, chemistry foam test was performed first as follows. A drop of the 25% imide-containing compound or benchmark product was added to a 60 mL centrifuge tube with 25 mL DI water, which was pre-heated to 50 degrees Celsius. Following the same steps as described above in the soap foam test procedure, the foam of the chemistry was tested. If there was no foam created by the chemistry itself, the chemistry was selected for antifoam testing. Right after the chemistry foam test, immediately 1, 2, or 3 drops of the 50% soap solution was added to the chemistry foam test tube. Following the same steps as described above in the soap foam test procedure, antifoam volume was obtained. The antifoam efficiency was determined according to the following equation: ((soap foam volume−antifoam volume)/soap foam volume)×100%.

As shown in Table 5, anti-foam and de-foam volumes of 0 mL translated to 100% anti-foam and de-foam efficiency.

TABLE 3
Anti-foam and de-foam performance of imide-containing compounds,
two drops 50% surfactant, compared to commercially available non-Si
containing foam control products (PPG4000 and Pluronic 25R2).

| | | Soap | | | | | |
|---|---|---|---|---|---|---|---|
| | Antifoam | Foam | Defoam | Antifoam | | Defoam | |
| Formula | (mL) | (mL) | (mL) | Efficiency | Average | Efficiency | Average |
| AA | 2.5 | 20 | 1 | 92.86% | 91.43% | 95.00% | 90.68% |
| | 3.5 | 22 | 3 | 90.00% | | 86.36% | |
| BB | 3 | 22 | 5 | 91.43% | 90.00% | 77.27% | 72.90% |
| | 4 | 27 | 8.5 | 88.57% | | 68.52% | |
| CC | 3 | 23 | 5 | 91.43% | 90.00% | 78.26% | 76.89% |
| | 4 | 24.5 | 6 | 88.57% | | 75.51% | |
| DD | 2 | 24.5 | 5 | 94.29% | 95.00% | 79.59% | 83.28% |
| | 1.5 | 23 | 3 | 95.71% | | 86.96% | |
| EE | 2.5 | 22 | 7.5 | 92.86% | 93.58% | 65.91% | 71.59% |
| | 2 | 22 | 5 | 94.29% | | 77.27% | |
| FF | 3 | 22.5 | 5 | 91.43% | 88.57% | 77.78% | 78.69% |
| | 5 | 24.5 | 5 | 85.71% | | 79.59% | |
| GG | 5 | 22.5 | 6 | 85.71% | 87.14% | 73.33% | 76.25% |
| | 4 | 24 | 5 | 88.57% | | 79.17% | |
| PPG4000 | 15 | 26 | 23.5 | 42.30% | 38.40% | 9.60% | 12.60% |
| | 19 | 29 | 24.5 | 34.50% | | 15.50% | |
| Pluronic | 21 | 27 | 26 | 22.20% | | 3.70% | |
| 25R2 | | | | | | | |

PPG4000 is a non-Si defoam/antifoam benchmark: PO homopolymer with Mn 4000 Daltons. Pluronic 25R2 is a non-Si defoam/antifoam benchmark: PO/EO block polymer (PO)21-(EO)14-(PO)21.

TABLE 4
Anti-foam and de-foam performance of imide-containing
compounds, three drops 50% surfactant.

| | | Soap | | | | | |
|---|---|---|---|---|---|---|---|
| | Antifoam | Foam | Defoam | Antifoam | | Defoam | |
| Formula | (mL) | (mL) | (mL) | Efficiency | Average | Efficiency | Average |
| AA | 7 | 36 | 18.5 | 80.00% | 77.15% | 48.61% | 51.33% |
| | 9 | 37 | 17 | 74.29% | | 54.05% | |
| BB | 11 | 37.5 | 12 | 68.57% | 68.57% | 68.00% | 60.03% |
| | 11 | 36.5 | 17.5 | 68.57% | | 52.05% | |
| CC | 5.5 | 36.5 | 13 | 84.29% | 82.15% | 64.38% | 58.86% |
| | 7 | 37.5 | 17.5 | 80.00% | | 53.33% | |
| DD | 2 | 37 | 13.5 | 94.29% | 90.00% | 63.51% | 66.22% |
| | 5 | 37 | 11.5 | 85.71% | | 68.92% | |
| EE | 7.5 | 37.5 | 11 | 78.57% | 82.10% | 70.67% | 59.63% |
| | 6.5 | 36.5 | 18.5 | 81.43% | | 49.32% | |
| | 5 | 36.5 | 15 | 86.30% | | 58.90% | |
| FF | 6 | 36.5 | 9 | 82.86% | 80.00% | 75.34% | 68.75% |
| | 8 | 37 | 14 | 77.14% | | 62.16% | |
| GG | 8.5 | 37.5 | 17.5 | 75.71% | 75.00% | 53.33% | 46.94% |
| | 9 | 37 | 22 | 74.29% | | 40.54% | |

TABLE 5
Anti-foam and de-foam performance of imide-containing
compounds, one drop of 50% surfactant.

| | | Soap | | | |
|---|---|---|---|---|---|
| | Antifoam | Foam | Defoam | Antifoam | Defoam |
| Formula | (mL) | (mL) | (mL) | Efficiency | Efficiency |
| AA | 0 | 12 | 0 | 100.00% | 100.00% |
| BB | 0 | 8.5 | 0 | 100.00% | 100.00% |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are number average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method for reducing an amount of foam in a medium, the method comprising:
adding an anti-foam composition to the medium, the anti-foam composition comprising an imide-containing compound; and
reducing the amount of foam in the medium.

2. The method of claim 1, wherein the imide-containing compound is a product of a reaction comprising a cyclic compound comprising an alkyl α-olefin and an amine.

3. The method of claim 2, wherein the alkyl α-olefin is a C₅ to C₆₀ α-olefin.

4. The method of claim 1, wherein the imide-containing compound comprises the following formula: 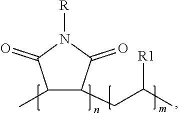
wherein R is H, a substituted or un-substituted, saturated or unsaturated C₁ to C₂₂ alkyl, alkenyl, alkynyl, or aryl group, and the substituted, saturated or unsaturated C₁ to C₂₂ alkyl, alkenyl, alkynyl, or aryl group includes an oxygen-containing group, a nitrogen-containing group, a phosphorus-containing group, or a sulfur-containing group,
wherein n is an integer from about 1 to about 10,000, wherein m is an integer from about 1 to about 10,000, and
wherein R₁ is a substituted or un-substituted, saturated or unsaturated C₃ to C₅₈ alkyl, alkenyl, alkynyl, or aryl group.

5. The method of claim 1, wherein the imide-containing compound comprises the following formula: 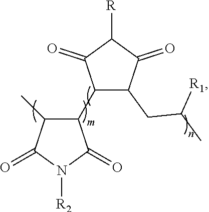
wherein R is H, a substituted or un-substituted, saturated or unsaturated C₁ to C₂₂ alkyl, alkenyl, alkynyl, or aryl group, and the substituted, saturated or unsaturated C₁ to C₂₂ alkyl, alkenyl, alkynyl, or aryl group group includes an oxygen-containing group, a nitrogen-containing group, a phosphorus-containing group, or a sulfur-containing group,
wherein m is an integer from about 1 to about 3,000
wherein n is an integer from about 1 to about 10,000,
wherein R₁ is a substituted or un-substituted, saturated or unsaturated C₃ to C₅₈ alkyl, alkenyl, alkynyl, or aryl group, and
wherein R₂ is H, a substituted or un-substituted, saturated or unsaturated C₁ to C₂₂ alkyl, alkenyl, alkynyl, or aryl group, and the substituted, saturated or unsaturated C₁ to C₂₂ alkyl, alkenyl, alkynyl, or aryl group includes an oxygen-containing group, a nitrogen-containing group, a phosphorus-containing group, a sulfur-containing group, or any combination thereof.

6. The method of claim 1, wherein the imide-containing compound comprises the following formula: 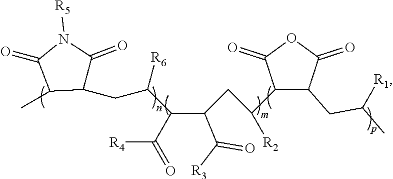
wherein R₁ is a substituted or un-substituted, saturated or unsaturated C₃ to C₅₈ alkyl, alkenyl, alkynyl, or aryl group,
wherein R₂ is a substituted or un-substituted, saturated or unsaturated C₃ to C₅₈ alkyl, alkenyl, alkynyl, or aryl group,
wherein R₃ is selected from an OH group, an amine group, a substituted or un-substituted, saturated or unsaturated C₃ to C₅₈ alkyl, alkenyl, alkynyl, or aryl group, an O-alkyl group, or an N-alkyl group,
wherein R₄ is selected from an OH group, a substituted or un-substituted, saturated or unsaturated C₃ to C₅₈ alkyl, alkenyl, alkynyl, or aryl group, an O-alkyl group, or an N-alkyl group,
wherein R₅ is H, a substituted or un-substituted, saturated or unsaturated C₁ to C₂₂ alkyl, alkenyl, alkynyl, or aryl group, and the substituted, saturated or unsaturated C₁ to C₂₂ alkyl, alkenyl, alkynyl, or aryl group includes an oxygen-containing group, a nitrogen-containing group, a phosphorus-containing group, or a sulfur-containing group,
wherein R₆ is a substituted or un-substituted, saturated or unsaturated C₃ to C₅₈ alkyl, alkenyl, alkynyl, or aryl group,
wherein n is an integer from about 1 to about 5,000,
wherein m is an integer from about 1 to about 5,000, and
wherein p is an integer from about 1 to about 5,000.

7. The method of claim 1, wherein the imide-containing compound comprises the following formula: 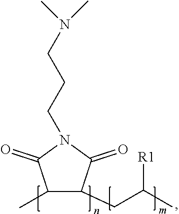
wherein R₁ is a substituted or un-substituted, saturated or unsaturated C₃ to C₅₈ alkyl, alkenyl, alkynyl, or aryl group,
wherein n is an integer from about 1 to about 10,0000 and
wherein m is an integer from about 1 to about 10,0000.

8. The method of claim 1, wherein the imide-containing compound comprises the following formula: 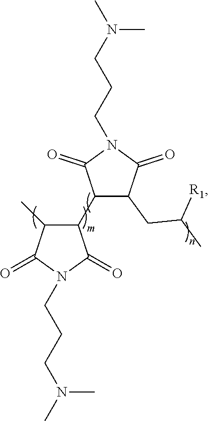
wherein R₁ is a substituted or un-substituted, saturated or unsaturated C₃ to C₅₈ alkyl, alkenyl, alkynyl, or aryl group,
wherein m is an integer from about 1 to about 3,000, and
wherein n is an integer from about 1 to about 10,000.

9. The method of claim 4, wherein R or R₂ is 3-(dimethylamino)-propyl.

10. The method of claim 1, wherein the composition excludes a silicon atom.

11. The method of claim 1, wherein the composition comprises a solvent.

12. The method of claim 11, wherein the solvent is selected from the group consisting of water, heavy aromatic naphtha, a refined petroleum solvent, xylene, toluene, kerosene, a hydrotreated light distillate hydrocarbon, a middle distillate hydrocarbon, diglyme, a plant-based oil, an alcohol, a polyol, an organic acid, and any combination thereof.

13. The method of claim 1, wherein the composition comprises from about 1 wt. % to about 100 wt. % of the imide-containing compound.

14. The method of claim 1, further comprising adding from about 0.1 to about 50,000 ppm of the imide-containing compound to the medium.

15. The method of claim 1, wherein the medium is selected from the group consisting of cooling water, papermaking process water, wastewater, warewashing water, paper/recycled pulp water, mining flotation pulp water, fossil fuel water, biofuel water, and any combination thereof.

16. The method of claim 1, wherein the imide-containing compound comprises a number average molecular weight of about 500 Da to about 5,000,000 Da.

17. The method of claim 1, wherein the anti-foam composition further comprises a solvent, an oil, a fatty acid, a fatty alcohol, a non-ionic surfactant, an ionic surfactants, a hydrotrope, or any combination thereof.

18. The method of claim 1, wherein the medium is selected from the group consisting of a polymer pellet composition, a delayed coker composition, a fuel composition, and an oil composition.

19. The method of claim 18, wherein the anti-foam composition is selected from the group consisting of a detacking composition, a fuel cloud point depressant, and a crude oil pour point depressant.
